(19) United States
(12) Patent Application Publication
(10) Pub. No.: US 2006/0080125 A1
(43) Pub. Date: Apr. 13, 2006

(54) Carpet simulation method

(76) Inventors: Andy Shipman, Leeds (GB); Jamie Harrison, Leeds (GB); Patrick Harris, Leeds (GB)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/219,448

(22) Filed: Sep. 2, 2005

Related U.S. Application Data
(60) Provisional application No. 60/607,318, filed on Sep. 3, 2004.

(51) Int. Cl. G06Q 99/00

(52) U.S. Cl. 705/1

(57) ABSTRACT

A new method of electronically distributing files containing information to permit the simulation of surface patterns is presented in which color characteristics, texture characteristics, and manufacturing characteristics are included in the file and once the file is loaded, no reference to external databases is required by viewing software.

### CROSS-REFERENCE TO RELATED APPLICATIONS

This invention is entitled to the priority of U.S. provisional application Ser. No. 60/607,318, filed Sep. 3, 2004, which is incorporated herein, and relates generally to the method of carpet simulation.

### FIELD OF THE INVENTION

The present invention relates to simulation technology, such as a technique of computer generation of images representative of real-world objects. More particularly, this invention relates to a method of computer simulated generation of surface patterns and the creation and use of data files for that purpose.

### BACKGROUND OF THE INVENTION

In the carpet industry, carpet samples are often provided to potential customers prior to the customer placing an order for carpet. Other samples may be used internally within a carpet manufacturer's business for product development work or for work with product designers. These samples may be manufactured on sample tufting machines, typically similar to production machines, only narrower in width. When large quantities of samples are distributed, the carpet samples may even be created on production equipment. Without regard to the quantity of carpet being produced, it is necessary to thread-up the tufting machine with yarns directed to designated needles. The tufting machine must be operated in accordance with the pattern to produce greige. The tufted greige generally must be finished as by tip-sharing and the application of a backing. Often completed samples are attached to carpet sample boards with descriptive and promotional text. The physical samples are then distributed to potential customers, are transported by salespeople to call upon accounts, or are located in business establishments used by interior decorators or visited by potential customers. A collection of physical carpet samples quickly becomes voluminous and can present space, transportation and storage problems.

In the prior art, it is known to use software to generate a representation of carpet. Such software has been used by designers to create new patterns for tufting machines, especially with the advent of computer controlled tufting machines in the late 1990's. However, this design software presented only a simple view of the patterns to be tufted and did not attempt to create a real simulation of the finished carpet product complete with yarn textures and shadows. The initial techniques for producing accurate graphical simulations of carpet with computer modeling involved the use of not only design software but databases of information corresponding to the yarns, tufting machines and patterns employed by a particular manufacturer. Specifically, databases were created to hold both the color palette of yarns available with the textures of the available yarns, and the tufting characteristics of the available tufting machines. The design software could then combine a selection of color, yarn characteristics and tufting machine characteristics with a pattern to create a simulation of a finished carpet product. Design software may advantageously store such a carpet simulation in an “.iff” (interchange file format) file. Such a file contains a pointer to the color or colors used in the carpet simulation and appropriate yarn characteristics that are stored in the color palette/yarn characteristic database; and a pointer to appropriate machine characteristics in the tufting machine characteristic database. When such “.iff” file is executed by the design software, the designated characteristics and colors are imported from the databases and a visual simulation of the carpet that would be manufactured according to the pattern is produced. When used with design software it is easy for the design operator to alter color and yarn characteristics and even pattern information. While this functionality is useful and desirable for carpet designers, it is unnecessary for many potential users of simulated carpet images.

Thus, while the prior art method of generating simulated carpet designs from “.iff” files is effective, it not only places a powerful design tool in the hands of the user, but also requires the use of additional databases containing colors, textures and tufting machine characteristics. It would be desirable to create a simulation viewer and file format that did not require additional databases to create a visual simulation of carpet, and which also did not provide the user with the ability to modify the carpet design in any way the user desired. Enhanced simulation viewers may also be provided to supply a user with limited capabilities to modify the pattern designs. For example, a colorist in product development work may be supplied with the ability to modify threading of the patterns and colors, or an interior designer can be supplied with the ability to change out colors or yarns in a pattern.

There is a need to send files to generate simulated carpet designs, and indeed other surface pattern designs without providing the user with design software. Preferably, the pattern simulation files may be stand alone files that do not require the use of external databases and the viewer software can generate carpet simulation in the size, resolution, and layout needed by the user.

### SUMMARY OF THE INVENTION

Therefore, it is an object of the present invention to provide a file format for use with creating simulations of surface patterns which contains all of the information necessary for viewing software to generate desired simulations.

Another object of the present invention is to provide a method of supplying pattern surface simulation files to users, which in connection with viewing software, are sufficient to generate simulation of the surface pattern independent of links to external databases.

It is yet another object of the present invention to provide a surface pattern simulation format containing color information, texture information, pattern information and manufacturing equipment information.

Another object of the present invention is to provide a method and file format for encapsulating an image as well as information required by viewing software to generate a pattern surface simulation.

Accordingly, according to the invention, a “.sim” file type or simulation file type is created which encapsulates specific color and texture data, as for yarns utilized in tufting, manufacturing machine characteristics, as needle gauge and stitch spacing for tufting machine operation, and the pattern to be created on a surface. This data is included in a single file and effectively comprises a recipe which can be read by “.sim” file viewing software to create a realistic pattern surface simulation, as for example a tufted carpet pattern simulation. Furthermore, the simulation file structure allows the inclusion of additional information such as a thumbnail image of the pattern, security features, version control, print layouts, and in appropriate instances a limited color palette, and data to facilitate management, searching, and review of the “.sim” files.

### BRIEF DESCRIPTION OF THE DRAWINGS

These and other features and advantages of the present invention will now be described in further detail with reference to the drawings of certain preferred embodiments and environments which constitute a part of the application and in which:

FIG. 1 illustrates local and wide area network configuration illustrative of the environment in which the invention may be employed.

FIG. 2 is a block diagram representation of a preferred file structure for simulation files according to the present invention.

### DETAILED DESCRIPTION OF THE INVENTION

Computer modeling can be utilized to create visual representations of products that are mechanically created. This is specifically true in the case of surface patterns where for general purposes it is only necessary to create two dimensional visual simulation of the surface covering product, such as a rug, carpet, wallpaper, fabric design or the like. The detailed discussion of the invention focuses on the specific application of the invention to the carpet industry, however, it is not intended to constrain the application of the invention to that industry. When carpet is manufactured, it is sometimes woven, but more commonly tufted. Tufting machines use needles to tuft yams through a backing fabric. Most tufting machines will have between about several hundred and two thousand laterally spaced needles, each provided with a yarn of preselected color. A backing fabric is fed from front to back beneath the tufting needles which move in a reciprocal fashion to drive their associated yarns through the backing fabric where the loops of yams are seized by hooks or loopers. Hooks are generally used in connection with knives to cut the tufted yam bights and create a cut pile surface, while loopers disengage from the tufted yarn bights to leave a loop pile surface. Hooks and loopers can be used in a variety of configurations, tufting needles can be spaced over a variety of lateral gauge widths, and the rate of feed of the backing fabric can be altered to create a variety of stitch lengths. In addition, yarns can be fed to selected needles at varying rates to create a variety of yarn pile heights, some heights being so low as to substantially bury a stitch of yarn between adjacent taller stitches. Accordingly, in creating design software to be compatible with a variety of manufacturers' tufting equipment, it was useful to create a database of these various tufting machine configuration characteristics. Similarly, for woven products, the database must include characteristics related to woven manufacturing techniques and variables.

In creating carpet design software, it was also necessary to represent the yarns used to manufacture the carpet. The first element of the yarns to be represented is color, and that color may be uniform, or varied depending upon the technique used to dye the yams, as in the case of spaced dyed yams.

In addition, yams may be manufactured in a variety of ways including the twisting of two, three, four or more single yarns to form a multi-ply yam having components of similar or varied colors. Yams may be air entangled or mechanically twisted, and the twist rates may vary. Yams may be made from a variety of materials including wool, nylon, and polypropylene, and the yams may have a variety of deniers or weights. In creating design software, databases to characterize all of these yarn features were created. In addition, it was necessary to provide precise calibration of colors to the output devices used to represent the carpet patterns.

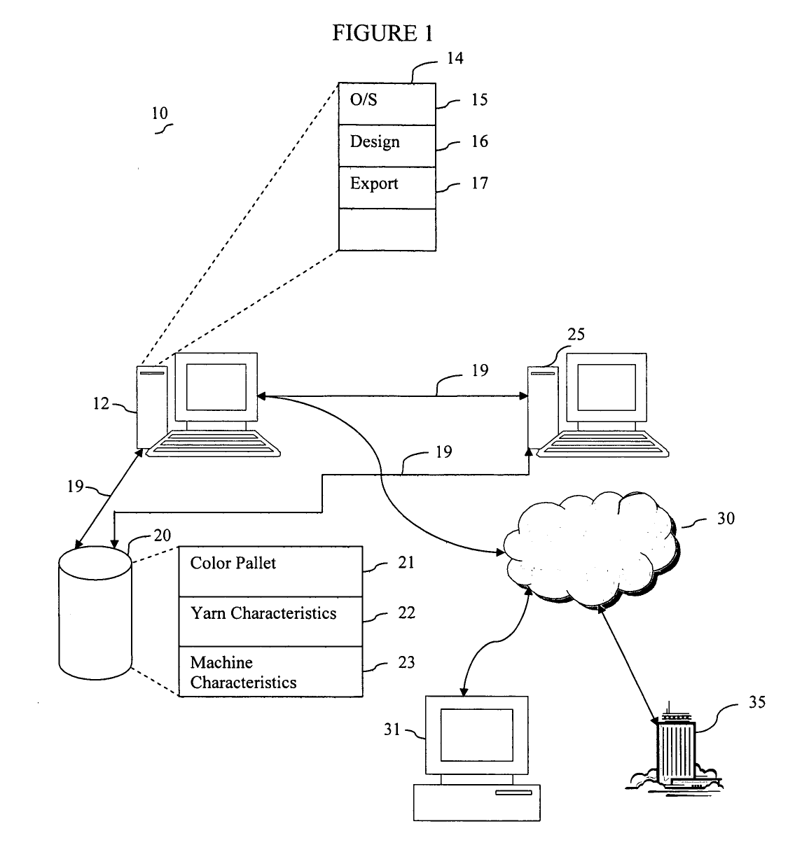

FIG. 1 shows a representative environment 10 with a design computer 12 with an operating program stack 14 showing the operation of an operating system 15, design software 16, and an export module 17. In operation, the design software 16 communicates with storage device 20 which may be on a local area network 19, as illustrated, or a storage device such as hard drive within work station 12. The storage device 20 preferably contains databases holding tufting machine characteristics 23, yam characteristics 22 and color palette 21 for a particular carpet manufacturer. In some cases, it may be appropriate to combine yarn characteristics and the color palette in a single database. Preferably, when a design is created on work station 12, that design is characterized in a “.iff” file which includes pointers to color, yarn characteristic and machine characteristic information in the databases on storage device 20 together with pattern information. When the “.iff” file is opened by the design software, it may be easily modified by the user changing to alternative colors or yams or even alternative tufting machine characteristics. The user of the design software has immediate access to the databases containing all of this information. The “.iff” (interchange file format) was introduced by Electronic Arts, Inc. in the 1980s and in this design application, the file format is preferably adapted to communicate pattern information with proprietary design software utilized by tufting equipment manufacturers and carpet manufacturers, in order to facilitate the exchange of data between design and production processing equipment. When a designer at work station 12 wishes to share a carpet design with a co-worker at work station 25 over LAN 19 or with an advertising agency or other service provider at computer 31 over wide area network or network of autonomous systems 30 the “.iff” file representing the carpet pattern can be transmitted electronically. However, this requires that the receiving computer or work station have access to the color palette 21, yarn characteristic 22 and machine characteristic 23 databases, and have software capable of interpreting the “.iff” file in conjunction with those databases.

To avoid having to equip all possible users with design software to interpret “.iff” files, it would be possible to simply transmit image files such as “.tiff” and “jpg”. However, to allow for the storage and transfer of high resolution image files, there may be substantial storage requirements. For instance, a “.tiff” file for a carpet pattern of a significant size and resolution of 300 dots per inch or more may require 100 megabytes of storage. A “jpg” file may be smaller, but loses some data due to compression. Furthermore, an image file is only a single image. Data transmitted by an image file does not allow the user the option of changing the resolution of the image file. Instead, a higher resolution image would require recreation of the image from the design software and retransmission of that file. The present invention avoids these shortcomings by providing a viewer software program designed to interpret a self-contained data file for surface pattern simulation. For the purposes of this application, the self-contained simulation data files are referred to as “.sim” files. Such files require a relatively small amount of storage space, require no external databases to interpret, and permit relatively widespread distribution of “.sim” viewer software without undercutting the market for design software.

Accordingly, according to the invention, when utilizing design software 16 at work station 12, the user may export a particular surface pattern design not simply as a “.iff” file or an image file, but instead may utilize a “.sim” file to designate a particular carpet pattern with particular yarn types and colors, tufted on a particular tufting machine setup. This “.sim” file may then be transmitted to a co-worker's work station 25 over local area network 19 or outside that network to the computer 31 of a third party such as a remote advertising or marketing service provider, or to a remote facility location 35 such as a retail carpet outlet or design mart. The “.sim” file may then be executed using viewer software to produce a screen display or in connection with a print engine, preferably color calibrated, to produce a simulation of the surface pattern on the printed sheet. A suitable “.sim” file may be relatively small, possibly only about 300 to 400 kilobytes for a typical pattern, but somewhat larger if all the additional functionality described herein is included.

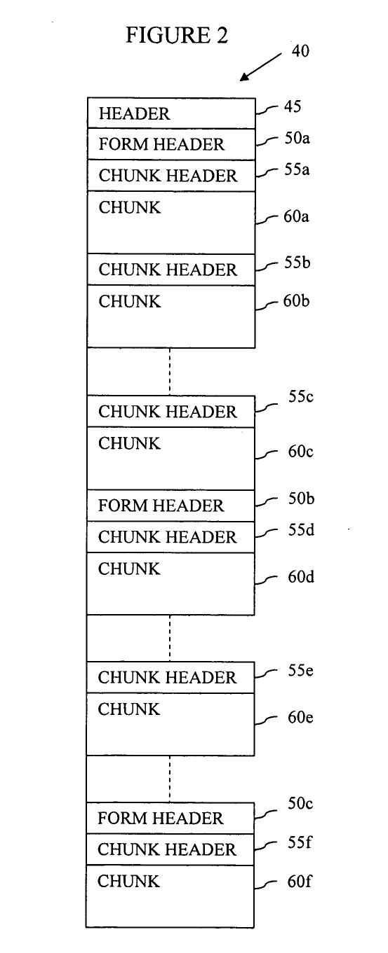

The encapsulation of the entire carpet pattern in a single “.sim” file provides numerous advantages. Each “.sim” file can be tracked to a specific destination when transmitted by the provider and electronic accountability of distribution of the files can be maintained. Furthermore, each “.sim” file represents only the specific carpet design or family of related designs contemplated by a particular manufacturer. The user of the viewer application cannot substitute colors or otherwise redesign the surface pattern in a fashion that is not specifically allowed by the distributor of the “.sim” file. Third, an image may be included within the file and a plurality of “.sim” files may be stored in a database with the images used for ease of selection. In addition to thumbnail image, additional data concerning patterns, such as particular tufting machine suitability, yarn types or color palettes, can be associated with the files so that they may be sorted by characteristics of the pattern. Accordingly, an extensible file format is shown in FIG. 2 which is suitable for use as a “.sim” file 40. The “.sim” file 40 will preferably consist of a header 45, containing general file information from which the viewing software can confirm that the file is indeed a “.sim” file and perhaps information concerning length or structure of the overall file. Within the file are one or more forms each prefaced by a form header 50 identifying the form type and length. If the viewer software does not recognize the form type, it may simply disregard the particular form and proceed to the next form in the file. In the event that a “.sim” file has only one form, the form header may not even be required. Within a particular form are one or more chunk headers 55 each with an associated chunk 60. Chunk headers 55 identify a chunk type and the length of the associated data in the chunk 60.

Thus, a thumbnail image of a particular surface pattern may be included in a chunk and identified by its associated chunk header and these chunks may be processed and displayed as a collection of thumbnail images for ease in browsing a plurality of “.sim” files. Similarly, the yarn color, texture, tufting machine and pattern characteristics are included in one or more chunks and appropriately identified by the associated headers. The color, texture, machine and pattern information is processed by viewing software to create and display the carpet surface pattern on the computer monitor. The resolution of the pattern may be adjusted by the user, this is particularly the case when printing the simulated carpet patterns. While the user of the viewer software may simply have the simulation of the carpet surface pattern displayed on a monitor at a resolution of 72 dots per inch (dpi) for viewing, when actually printing that pattern, preferably to a color calibrated printing device, the software may provide for the user to set the printing resolution at a finer level such as up to about 360 dpi, or even finer resolutions. In addition to a thumbnail image, other images may also advantageously be included such as low resolution image of an entire repeat of the surface design. A diagram or chart showing a selection of variable characteristics of the carpet pattern may also be included, including alternatives such as cut pile effects compared to loop pile effects, or the appearance of the pattern with varied pile heights. Palette information may be provided if the specific carpet pattern is provided in more than one choice of yarn colors and may be included in appropriately headed chunk. This may allow the user to generate simulated images of the pattern in each of the color combinations made available by the manufacturer. Various textual information including extensive yarn details, product construction, and performance analyses may be included in an appropriately headed chunk. Similarly, all types of other information that might be usefully transmitted with a carpet pattern, including manufacturing and technical details in CAM or CAD formats; version control information reflecting the development of the pattern over time may be included; links to web accessible documents or sites, as for additional information or ordering may be included; and security information including intellectual property notices, encryption information, digital watermarks, password requirements, and electronic auditing information may be included in additional defined chunks. Print layouts including “.lyt” information or multiple “.lyt” formats may be provided in chunks within the file. The possibility for extending the “.sim” file format to provide the functionality desired by any particular user is virtually unlimited.

The user has the ability to search for chunks of particular type matching designated requirements. The “.sim” files matching a particular set of search parameters may be easily located and identified by returning useful indexing information such as displaying thumbnail pattern sketches. When printing a carpet pattern simulation from a displayed file, the viewer may not only permit the user to select the desired resolution for the print image, but may also permit selection of a particular print layout if “.lyt” information was provided, may permit the selection of a particular color palette if multiple colors were provided, and may permit the selection of particular effects such as cut or loop pile if this variation was included. After these selections, the viewing software then generates the print file according to the designated characteristics and the simulated carpet pattern image is generated, preferably on a color calibrated print device.

It can be seen that the distribution of simulated carpet pattern files provides great advantages not only within a business' local area network 19 where a remote user at work station 25 may have no need for full design software and characteristic databases but may only need to review or utilize finished designs. Similarly, simulated carpet pattern files may be transmitted over the Internet 30 to remote marketing and advertising service personnel using computers 31 with only viewer software. Such personnel typically need only to prepare advertising and marketing materials and do not require full design software access to extensive databases. Similarly, the “.sim” simulated surface pattern files may be provided to remote facilities 35 such as a design mart that may print copies of selected carpet pattern simulations for decorators or retail carpet store that may print simulated carpet designs for potential customers. Depending upon the purpose for which the pattern is printed, the associated print layout may include manufacturer logo, contact information, pattern numbers and the like. Alternatively, a remote user may utilize a reader to view “.sim” files that are hosted on a manufacture's website or otherwise provided remotely, and the selected carpet pattern simulations may be printed by the carpet manufacturer and mailed to the remote user. Search criteria are available for such remote user as well as for users who acquire actual copies of “.sim” files for use with the viewing software on their own computers.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

We claim:

1. A method of distributing surface pattern simulations comprising the steps of:
(a) creating a file containing color, texture and manufacturing characteristics, and pattern information;
(b) transmitting the file to a user with access to viewing software;
(c) operating the viewing software to open the file and create a surface pattern simulation without reference to external databases of color, texture or manufacturing characteristics.

2. The method of claim 1 wherein the user selects the resolution of the surface pattern simulation.

3. The method of claim 1 wherein the file is defined in an extensible file format and also includes thumbnail image of the surface pattern.

4. The method of claim 1 wherein the file is defined in an extensible file format and also includes a print layout.

5. The method of claim 1 wherein the surface pattern simulation is created on a color calibrated print device.

6. The method of claim 1 wherein the file includes a user selectable color choice.

7. The method of claim 1 wherein the surface pattern simulation is a representation of a carpet pattern and the texture characteristics are yarn texture characteristics.

8. The method of claim 1 wherein the file created encapsulates the entirety of the data required by the viewing software to create the surface pattern simulation.

9. The method of claim 1 wherein the file includes a user selectable yarn characteristic choice.

10. The method of claim I wherein the file includes a user selectable choice from at least one of multiple patterns and multiple machine characteristics.

11. The method of claim 2 wherein the surface pattern simulation is created as a first generation image at each user selected resolution.

12. A file for use with viewer software to generate surface pattern simulations in an extensible format comprising a file header, a first chunk header and an associated first chunk containing at least one of color, texture and manufacturing characteristics, and pattern information.

13. The file of claim 12 further comprising a second chunk header and an associated second chunk containing a thumbnail image of the surface pattern.

14. The file of claim 12 wherein the file has a first form with a form header and containing the first chunk header and associated first chunk containing at least one of color, texture and manufacturing characteristics, and pattern information.

15. The file of claim 12 further comprising a second chunk header and an associated second chunk containing an alternative of at least one of color, texture and manufacturing characteristics, and pattern information.

16. The file of claim 12 further comprising a second chunk header and an associated second chunk containing at least one print layout.

17. The file of claim 12 further comprising a second chunk header and an associated second chunk containing at least one of product details, product illustrations, and historical pattern information.

18. The file of claim 12 further comprising a second chunk header and an associated second chunk containing at least one of intellectual property notices, encryption information, watermarks, password information, auditing information, and pattern version control information.

19. The file of claim 12 further comprising a second chunk header and an associated second chunk containing searchable data corresponding to a characteristic of the surface pattern.

20. A method of distributing surface pattern simulations comprising the steps of:
(a) creating a file containing color, texture and manufacturing characteristics,. and pattern information in an extensible format comprising a file header, a first chunk header and an associated first chunk containing at least one of color, texture and manufacturing characteristics, and pattern information, a second chunk header and an associated second chunk containing a thumbnail image of the surface pattern, a third chunk header and an associated third chunk containing at least one print layout.;
(b) transmitting the file to a user with access to viewing software;
(c) operating the viewing software to open the file and create a surface pattern simulation at a user selected resolution on a color calibrated print device without reference to external databases of color, texture or manufacturing characteristics as the file encapsulates the entirety of the data required by the viewing software to create the surface pattern simulation.
